(19) United States
(12) Patent Application Publication
(10) Pub. No.: US 2018/0158379 A1
(43) Pub. Date: Jun. 7, 2018

(54) SHEET STRETCHING DEVICE

(71) Applicants: Fumito KOBAYASHI, Tokyo (JP); RIDEAWORKS Inc., Tokyo (JP)

(72) Inventor: Fumito KOBAYASHI, Tokyo (JP)

(21) Appl. No.: 15/576,033

(22) PCT Filed: Jul. 27, 2016
(86) PCT No.: PCT/JP2016/072087

§ 371 Date: Nov. 21, 2017

(30) Foreign Application Priority Data
Jul. 30, 2015 (JP) 2015-151037

(51) Int. Cl. G09F 7/18; G09F 15/00

(52) U.S. Cl. CPC G09F 7/18; G09F 2015/0093; G09F 15/00

(57) ABSTRACT

A sheet stretching device is provided which is capable of preventing a sheet from being slacked, with the sheet stretched over a frame, by possibly preventing unnecessary motions of a retaining member for fixedly drawing the sheet into the frame.

A retaining groove (2a) is formed along the length direction of the frame on the front surface side of a frame (2). Retaining plates (4), with a rectangular cross section, to be fitted into the retaining groove are attached to the peripheral edge portion of a sheet (3). The retaining plate is formed of an elastic material and substantially equal in thickness to the width of the retaining groove. A plurality of projections (4a) at certain intervals in the depth direction of the retaining groove are formed on at least one of the inner wall surface of the retaining groove and the side surface of the retaining plate.

### TECHNICAL FIELD

The present invention relates to a sheet stretching device which is used to attach a sheet to a frame so as to cover a portion surrounded by the frame.

### BACKGROUND ART

In general, a sheet with logos or ads printed thereon, a plain sheet, a cloth sheet, or a decorative pattern sheet is attached to a frame so as to cover a portion surrounded by the frame, thereby serving as a panel-shaped display or an indoor partition.

Then, to attach the sheet to the frame, the frame is provided with a retaining groove formed in the length direction of the frame, and then covered with the sheet over the retaining groove. After that, a retaining member that has been brought into contact with a surface of the sheet is pushed into the retaining groove in conjunction with the sheet. This allows the peripheral edge portion of the sheet to be sandwiched between the inner surface of the retaining groove and the retaining member, and the sheet to be thereby fixed to the frame.

Furthermore, for example, as disclosed in Patent Literature 1, the retaining member is fixedly attached to the rear surface side of the sheet by thermal fusion or adhesion, and then the retaining member is pushed into the retaining groove of the frame, thereby securing the sheet to the frame.

In this technique, the peripheral edge portion of the sheet covers the retaining groove and the retaining member that has been pushed into the retaining groove.

As a result, unnecessary members are never exposed from the peripheral edge portion of the sheet, thus maintaining the design effects applied to the sheet.

### CITATION LIST

### Patent Literature

Patent Literature 1: Japanese Patent Application Laid-Open No. 2007-327257

### SUMMARY OF INVENTION

### Technical Problem

In the conventional technique mentioned above, the following problems that are to be improved are remained unaddressed.

That is, the sheet is secured to the retaining member by adhesion or thermal fusion. However, in the former case, it is expected that the adhesive force may not withstand the tension caused by the sheet being stretched, and in the latter case, the device may be increased in size and thus invite an increase in manufacturing costs.

Furthermore, the friction between the retaining member and the retaining groove is employed to support the tension given to the sheet to stretch the sheet. However, the following problems may be expected due to the fact that the retaining member is circular in cross section.

When the tension given to the sheet acts on the retaining member, the tension serves to rotate the retaining member, and this rotation in turn causes the retaining member to move toward the opening of the retaining groove, thereby reducing the tension.

The reduction in the tension given to the sheet will result in the sheet being slacked and wrinkled.

Then, the sheet wrinkled may cause the design applied to the sheet to be distorted, impairing the primary effects of the design.

The present invention was developed in view of the problems remained unaddressed in the conventional technique mentioned above. It is therefore the problem to be addressed by the invention to provide a sheet stretching device which is capable of preventing a sheet from being slacked, with the sheet stretched over a frame, while possibly preventing unnecessary motions of a retaining member for fixedly drawing the sheet into the retaining groove.

### Solution to Problem

A sheet stretching device of the present invention attaches a sheet to a frame over a portion surrounded by the frame. The sheet stretching device is characterized in that a retaining groove is formed along a length direction thereof on a front surface side of the frame; a retaining plate, with a rectangular cross section, to be fitted into the retaining groove is attached to a peripheral edge portion of the sheet; the retaining plate is formed of an elastic material and substantially equal in thickness to a width of the retaining groove; a plurality of projections are formed, at certain intervals in a depth direction of the retaining groove, on a side surface of the retaining plate opposite to a side surface to which the sheet has been attached; and with the retaining plates that are parallel to each other and fitted into the retaining grooves that oppose in parallel to each other, a distance between portions of the retaining plates protruded from the retaining grooves is substantially equal to or less than a distance between the retaining grooves.

With the sheet stretched, such a configuration allows the retaining plate and the retaining groove to be brought into contact with each other via the plurality of projections.

Here, since the plurality of projections are formed at certain intervals in the depth direction of the retaining groove, the retaining plate is supported in the retaining groove at a plurality of points at certain intervals in the depth direction.

As a result, the tension of the sheet acting on the retaining plate prevents the retaining plate to be rotated and provides the retaining plate with a great frictional force in the depth direction of the retaining groove.

These synergistic effects constrain unnecessary motions of the retaining plate and prevent the tension of the stretched sheet from being slacked.

Thus, the design applied to the sheet is prevented from being distorted, thus preventing the effects of the design from being impaired.

The retaining plate is preferably attached to the rear surface side of the sheet.

With the retaining plate fitted in the retaining groove to stretch the sheet, such a configuration allows the retaining groove and retaining plate to be covered with the sheet and thereby hidden.

This enables the peripheral edge portion of the sheet to be accommodated in a visually simplified manner and enhance the entire design property including the frame when the sheet is stretched.

On the other hand, as described above, since the retaining plate is effectively retained in the retaining groove, the retaining plate can be retained with part thereof protruded from the retaining groove.

Here, to stretch the sheet, the retaining plates have to be fitted into the respective retaining grooves that are spaced from each other.

Then, to impart adequate tension to the stretched sheet, the distance between the retaining plates to be fitted into the retaining grooves has to be less than the distance of the retaining groove sweat.

When such a size is set, as described above, the end portion of the retaining plate to which the sheet is connected is to be located at an inner position than the retaining groove. However, this difference in distance is allowed by the elasticity of the protruded portion of the retaining plate, by part of the retaining plate being retained as protruded from the retaining groove.

Furthermore, when the tension imparted to the sheet is reduced, for example, due to the elongation of the sheet after stretched, the protruded portion of the retaining plate can be pushed into the retaining groove, thereby widening the distance between the retaining plates so as to recover the tension of the sheet.

It is thus possible to impart an adequate tension to the sheet to thereby prevent a slack thereof.

It is also possible to form, inside the retaining plate, a through hole along the length direction thereof.

Such a configuration can enhance the flexibility of the retaining groove in the width direction while preventing the distortion of the retaining plate in the depth direction of the retaining groove.

Thus, as described above, with the retaining plate projected from the retaining groove, the retaining plate is easily elastically deformed to facilitate accommodation of the size difference mentioned above.

Or alternatively, the accommodation range can be widened.

Then, the frame can be formed in a polygonal shape or circular shape, so that as the frame approaches a circular shape, the sheet can be more effectively stretched by reducing the length of the retaining plate.

### Advantageous Effects of Invention

According to the present invention, when the retaining plate attached to a sheet is fitted into the retaining groove formed in the frame to thereby stretch the sheet, unnecessary motions of the retaining plate relative to the retaining groove can be reduced to appropriately maintain the tension given to the sheet. This prevents the sheet from being slacked, and the design of the sheet can be secured.

### BRIEF DESCRIPTION OF DRAWINGS

FIG. 1 is a perspective view illustrating an outer appearance of a first embodiment of the present invention.

FIG. 2 is an exploded perspective view of the first embodiment of the present invention.

FIG. 3 is a front view illustrating a sheet of the first embodiment of the present invention.

FIG. 4 is a rear view illustrating the sheet of the first embodiment of the present invention.

FIG. 5 is an enlarged cross-sectional view, taken along line V-V of FIG. 4, illustrating the first embodiment of the present invention.

FIG. 6 is an enlarged cross-sectional view illustrating a main portion in the procedure of stretching a sheet according to the first embodiment of the present invention.

FIG. 7 is an enlarged cross-sectional view illustrating the main portion in the procedure of stretching the sheet according to the first embodiment of the present invention.

FIG. 8 is an enlarged cross-sectional view illustrating the main portion in the procedure of stretching the sheet according to the first embodiment of the present invention.

FIG. 9 is an enlarged cross-sectional view illustrating a main portion according to a modified example of the present invention.

FIG. 10 is an enlarged cross-sectional view illustrating a main portion according to another modified example of the present invention.

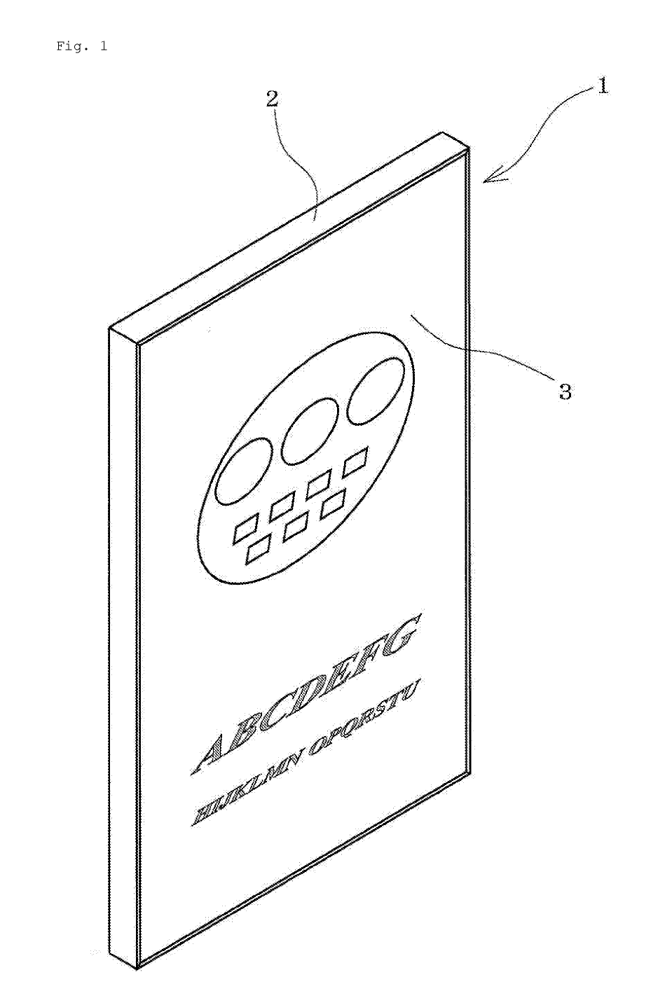

### DESCRIPTION OF EMBODIMENTS

A description will next be given of a first embodiment of the present invention with reference to the drawings.

In the figures, reference numeral 1 denotes a billboard to which this embodiment is applied and which is provided with a rectangular frame 2, and a sheet 3 that is stretched across the front surface of the frame 2 so as to cover a portion surrounded by the frame.

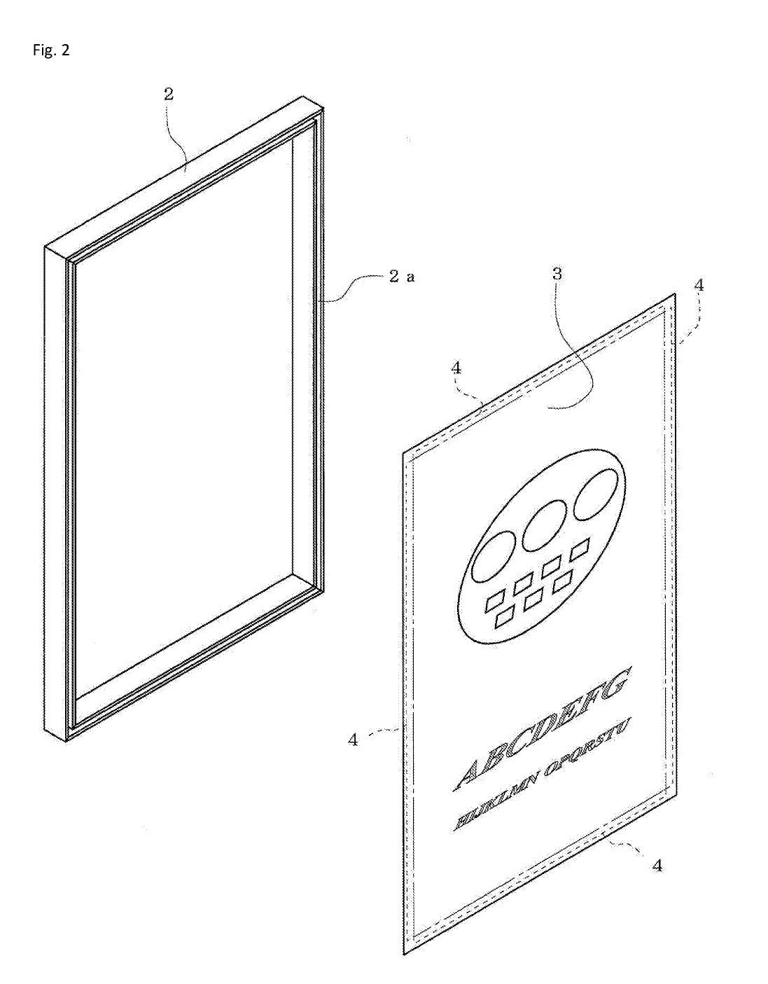

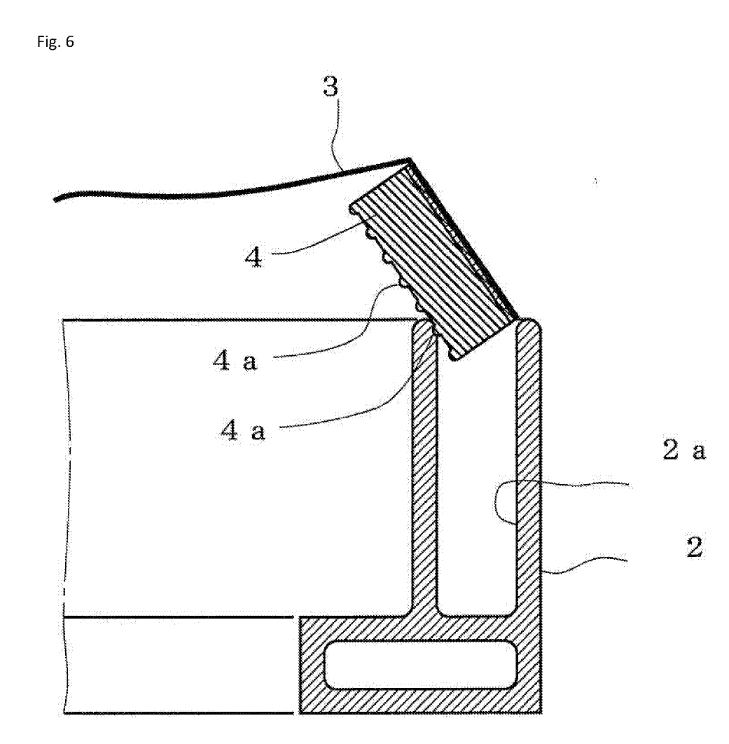

As shown in FIG. 2, the front surface of the frame 2 is provided with a retaining groove 2a formed along the length direction, and as shown in FIG. 6, the retaining groove 2a is formed with a substantially constant width along the total length of the frame 2 and thus formed in the same rectangular shape as the frame 2.

The sheet 3 is formed of cloth or a resin film, and has similitude relations with and slightly larger in shape than the rectangular shape defined by the retaining groove 2a. For example, preferredly employed as the sheet 3 is a sheet with a logo or ads printed, a plain sheet, a cloth sheet, or a decorative pattern sheet.

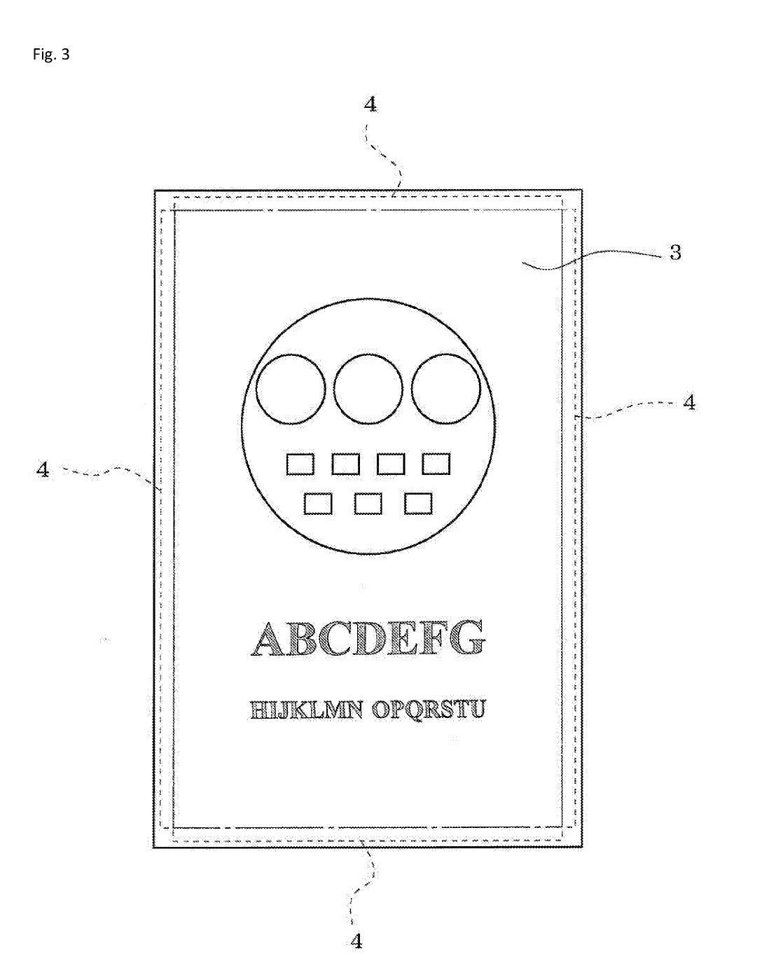

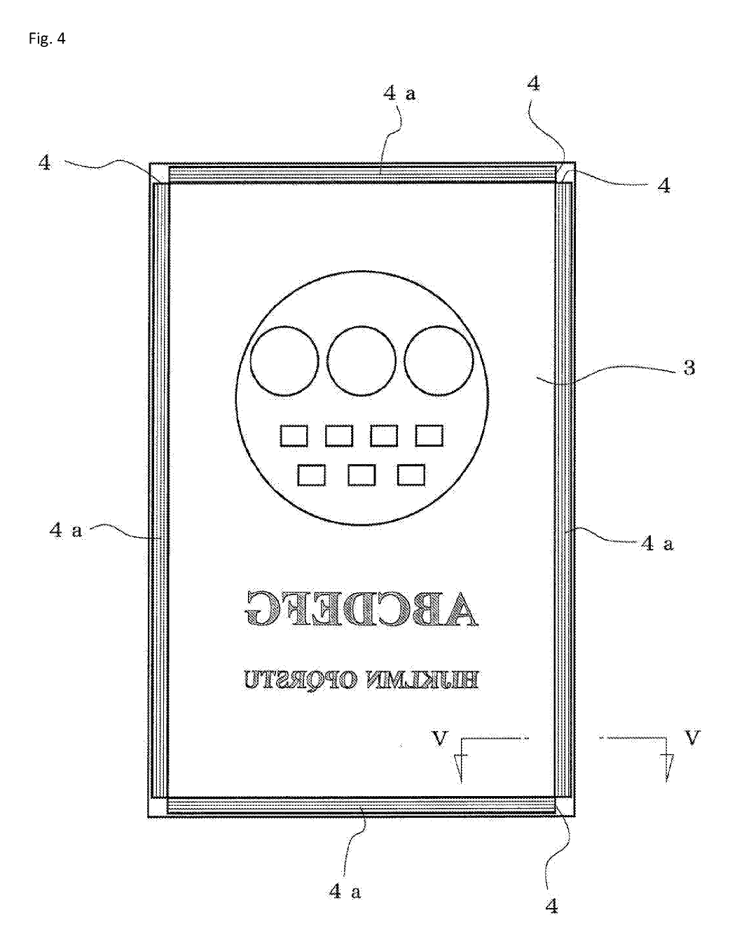

Then, as shown in FIG. 2 to FIG. 4, the rear surface of the sheet 3 is provided with four retaining plates 4 fixedly attached thereto along each side of the peripheral edge portion thereof.

For example, these retaining plates 4 are formed of an elastic material such as a silicone resin, and the distance between opposing parallel retaining plates 4 is set to be substantially equal to or less than the distance between opposing parallel retaining grooves 2a among those formed in the frame 2. For example, the retaining plates 4 can be formed of cardboard, corrugated cardboard, or foam materials.

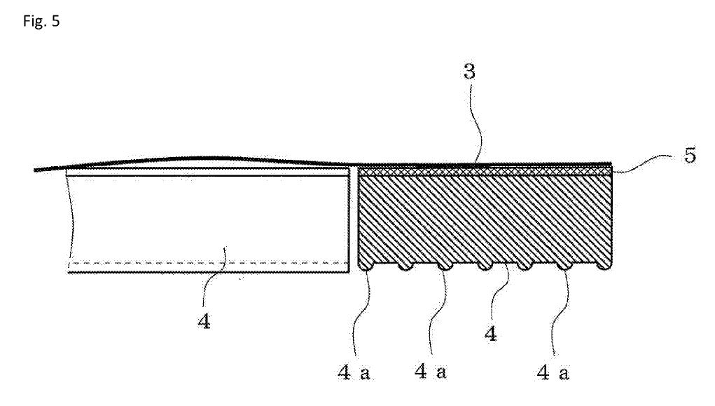

Furthermore, the thickness of each of the retaining plates 4 is substantially the same as the width of the retaining groove 2a, and as shown in FIG. 5, a plurality of projections 4a at certain intervals in the width direction (the right-and-left direction in FIG. 5) are formed on one side in the thickness direction.

As shown in FIG. 5, on the side on which no projections 4a are formed, such retaining plates 4 are fixedly attached to the peripheral edge portion of the sheet 3 with an adhesive 5 such as double-sided tape.

Note that methods for attaching the sheet 3 to the retaining plates 4 are conceivable to include, in addition to sewing, a method using a stapler, a method utilizing adhering, fusing, or melting, and a method using a structural function for sandwiching the plate.

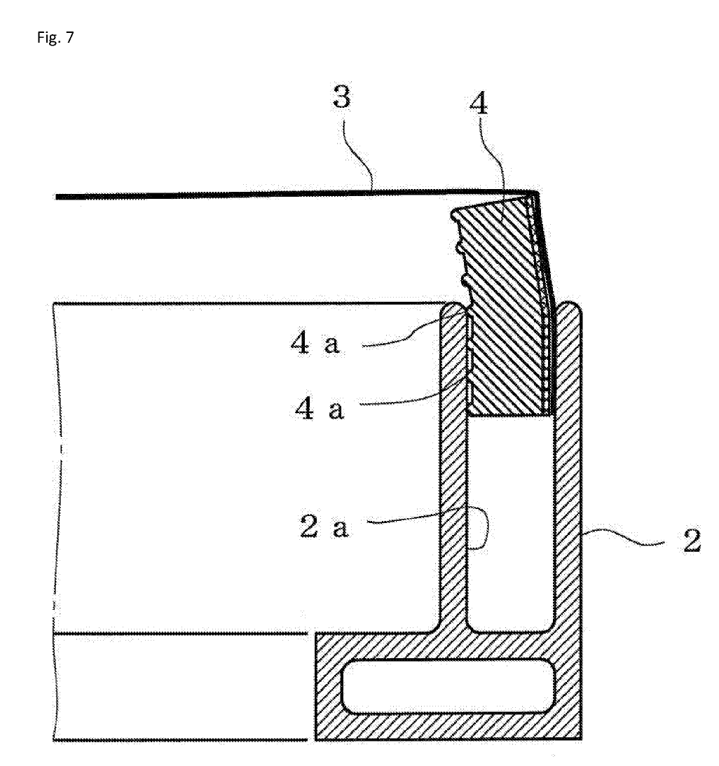

Next, referring to FIGS. 6 and 7, a description will be given of the steps of stretching the sheet 3 over the frame 2 according to this embodiment that is configured as described above.

First, as shown in FIG. 6, the peripheral edge portion of the sheet 3 is bent so that the retaining plate 4 is located on the rear surface side, and then the retaining plate 4 is inserted into the retaining groove 2a of the frame 2.

Next, the retaining plate 4 is further pushed into the retaining groove 2a until, as shown in FIG. 7, part of the retaining plate 4 is positioned to be protruded from the retaining groove 2a.

Here, when the distance between the retaining plates 4 is set to be less than the distance between the retaining grooves 2a, the difference therebetween is accommodated by the elastic deformation of the protruded portion of the retaining plate 4 as shown in FIG. 7.

On the other hand, the portion other than the protruded portion is pushed into the retaining groove 2a so as to be pushed under pressure against both the inner walls of the retaining grooves 2a.

Here, one side surface of the retaining plate 4 is brought into contact with one inner surface of the retaining groove 2a in conjunction with the sheet 3, and the other side surface is brought into contact with the inner wall of the retaining groove 2a via the plurality of projections 4a at a plurality of points at certain intervals in the depth direction.

If an external force is applied in the depth direction of the retaining groove 2a, this configuration causes the retaining plates 4 to be moved so as to be dislodged therefrom. However, an external force in a direction other than the depth direction would cause the retaining plates 4 to hold the positions thereof.

Thus, the retaining plates 4 are secured with reliability to the position protruded from the retaining groove 2a, allowing the protruded portion to be held in an elastically deformed state.

This allows the sheet 3 to be stretched while being provided with tension by the elasticity of the retaining plates 4.

As a result, when stretched, the sheet 3 is normally provided with tension and prevented from being slacked, and maintains the effects of design thereof.

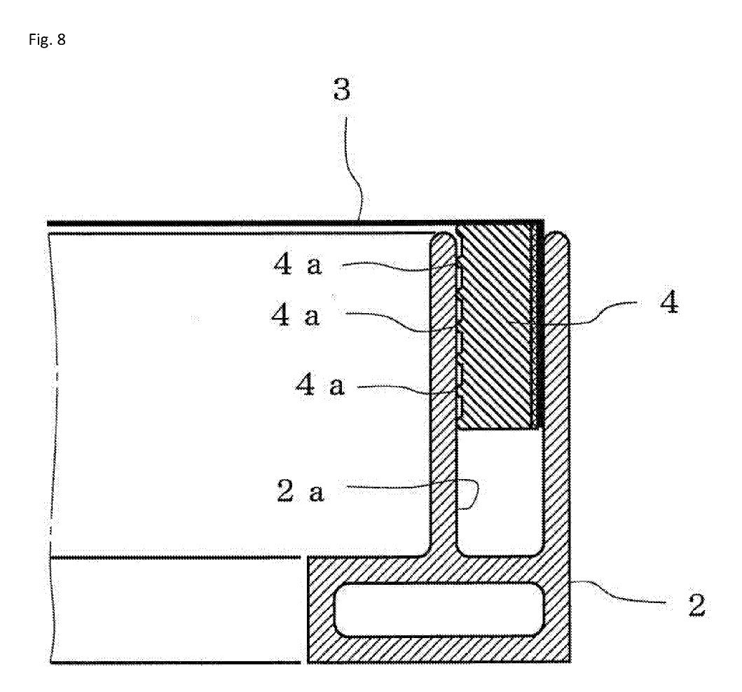

On the other hand, more tension may need to be applied to the sheet 3, for example, when the sheet 3 is slacked due to the elongation of the sheet 3. In this case, as shown in FIG. 8, this need can be satisfied by further pushing the retaining plates 4 into the retaining groove 2a.

Such a manipulation causes the protruded portion of the retaining plates 4 to be pushed into the retaining groove 2a, and thereby pushed outwardly.

As a result, the tension given to the sheet 3 is increased to thereby eliminate the slack.

Then, adjusting the position of the retaining plate 4 being pushed in enables the tension given to the sheet 3 to be adjusted, thus facilitating adjustment of the tightness of the sheet 3.

On the other hand, as described above, the retaining plates 4 are effectively prevented from being moved by an external force, such as the tension, in a direction intersecting the depth direction of the retaining groove 2a, but can be relatively easily moved by an external force in the depth direction of the retaining groove 2a because of the reduction of frictional resistance caused by the presence of the projections 4a.

Thus, the retaining plates 4 can be relatively easily extracted or inserted, thereby enabling replacement of the sheet 3 in a simplified manner.

Note that the various shapes and sizes of each of the components illustrated in the embodiment were shown only as an example, and thus may be modified in a variety of ways according to design requirements.

For example, in the embodiment, such an example was shown in which the projections 4a are formed on the retaining plate 4. However, the projections 4a may be formed on the inner wall of the retaining groove 2a, or alternatively, may also be formed on both the retaining plate 4 and the retaining groove 2a.

Furthermore, in the embodiment, the rectangular frame 2 was illustrated as an example. However, the frame 2 may also be formed in a triangular shape, in a polygonal shape with five or more corners, or alternatively in a circular shape.

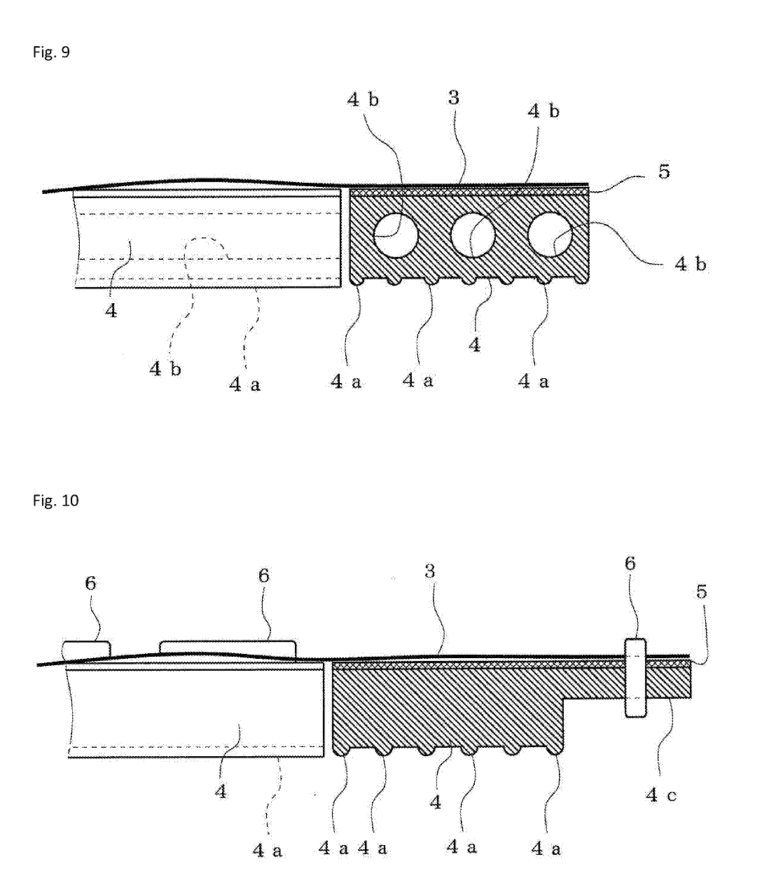

Furthermore, as shown in FIG. 9, it is also possible to form through holes 4b in the retaining plate 4.

This enables fine adjustments of the tension given to the sheet 3 by reducing the elastic modulus of the retaining plate 4.

Furthermore, as shown in FIG. 10, one side portion of the retaining plate 4 may also be provided with a reduced-thickness portion 4c.

Such a structure enables the retaining plate 4 and the sheet 3 to be connected to each other at the reduced-thickness portion 4c using a fixing member 6 such as a stapler.

That is, if the retaining plate 4 is increased in thickness when using the fixing member 6 like a stapler, the fixing member 6 will be less prone to being penetrated through the retaining plate 4, allowing the retaining plate 4 to be connected with difficulty.

In this context, forming the reduced-thickness portion 4c described above facilitates penetration of the fixing member 6 like the stapler to thereby enable connection with the fixing member 6.

The retaining plate 4 and the sheet 3 are connected to each other with the fixing member 6 that penetrates therethrough, thereby significantly improving the connection strength therebetween.

Note that for materials of the retaining plate 4, a plurality of materials can be used, thereby achieving cost reduction and high productivity. Examples thereof may include applying a resin to cardboards, enabling domestic sewing machines to sew cloth attached to a resin, applying a resin to cloth itself, or combining a push support vinyl chloride plate material with a foaming material.

Furthermore, in the aforementioned embodiments, such an example was illustrated in which the frame is provided with the retaining groove 2a, and the retaining plates 4 with the sheet 3 attached thereto are inserted into the retaining groove 2a, thereby stretching the sheet 3. It is also possible to employ such a structure in which the retaining groove 2a may be provided, for example, on a wall surface, and the retaining plates 4 with the sheet 3 attached thereto are inserted into the retaining groove on the wall surface, thereby stretching the sheet 3. Furthermore, without being limited to the wall surface, for example, it is also possible to employ such a structure in which the retaining groove 2a may be provided on the surface of a rectangular plate material, and the sheet 3 is stretched over the surface of the plate material.

### REFERENCE SIGNS LIST

1 billboard
2 frame
2a retaining groove
3 sheet
4 retaining plate
4a projection
4b through hole
4c reduced-thickness portion
5 adhesive
6 fixing member

1. A sheet stretching device for attaching a sheet to a frame over a portion surrounded by the frame, characterized in that:
a retaining groove is formed along a length direction thereof on a front surface side of the frame;
a retaining plate, with a rectangular cross section, to be fitted into the retaining groove is attached to a peripheral edge portion of the sheet;
the retaining plate is formed of an elastic material and substantially equal in thickness to a width of the retaining groove;
a plurality of projections are formed, at certain intervals in a depth direction of the retaining groove, on a side surface of the retaining plate opposite to a side surface to which the sheet has been attached; and
with the retaining plates that are parallel to each other and fitted into the retaining grooves that oppose in parallel to each other, a distance between portions of the retaining plates protruded from the retaining grooves is substantially equal to or less than a distance between the retaining grooves.

2. The sheet stretching device according to claim 1, characterized in that the retaining plate is formed to be shorter than the depth of the retaining groove.

3. The sheet stretching device according to claim 1, characterized in that a through hole is formed inside the retaining plate along the length direction thereof.

4. The sheet stretching device according to of claim 1, characterized in that the frame is formed in a polygonal shape.

5. The sheet stretching device according to claim 1, characterized in that the frame is formed in a circular shape.

6. The sheet stretching device according to claim 1, characterized in that a projection is provided on an inner wall of the retaining groove.
